(19) United States
(12) Patent Application Publication
(10) Pub. No.: US 2026/0112233 A1
(43) Pub. Date: Apr. 23, 2026

(54) SYSTEM

(71) Applicant: SoftBank Group Corp., Tokyo (JP)

(72) Inventor: Maya OGAWA, Tokyo (JP)

(21) Appl. No.: 19/355,087

(22) Filed: Oct. 10, 2025

(30) Foreign Application Priority Data
Oct. 18, 2024 (JP) 2024-183633

(51) Int. Cl. G07F 17/32

(52) U.S. Cl. CPC G07F 17/3227; G07F 17/3239; G07F 17/3293

(57) ABSTRACT

The system according to the embodiment includes a proposal unit, a battle unit, an analysis unit, an improvement unit, and a digitization unit. The proposal unit proposes an optimal card deck based on the user's personality, preferred style, past deck information, and battle history. The battle unit conducts a virtual match against AI using the deck proposed by the proposal unit. The analysis unit visually analyzes the results of the match conducted by the battle unit. The improvement unit proposes improvements to the play style based on the results obtained by the analysis unit. The digitization unit digitizes usage information of physical decks.

### CROSS-REFERENCE TO RELATED APPLICATION

The present application claims priority to and incorporates by reference the entire contents of Japanese Patent Application No. 2024-183633 filed in Japan on Oct. 18, 2024.

### BACKGROUND OF THE INVENTION

### 1. Field of the Invention

The technology of this disclosure relates to the system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to practice assuming various match patterns in card games because there are few opportunities to build a deck that matches one's personality and way of thinking or to practice matches.

### SUMMARY OF THE INVENTION

The system according to the embodiment includes a proposal unit, a battle unit, an analysis unit, an improvement unit, and a digitization unit. The proposal unit proposes an optimal card deck based on the user's personality, preferred style, past deck information, and battle history. The battle unit conducts a virtual match against AI using the deck proposed by the proposal unit. The analysis unit visually analyzes the results of the match conducted by the battle unit. The improvement unit proposes improvements to the play style based on the results obtained by the analysis unit. The digitization unit digitizes usage information of physical decks.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

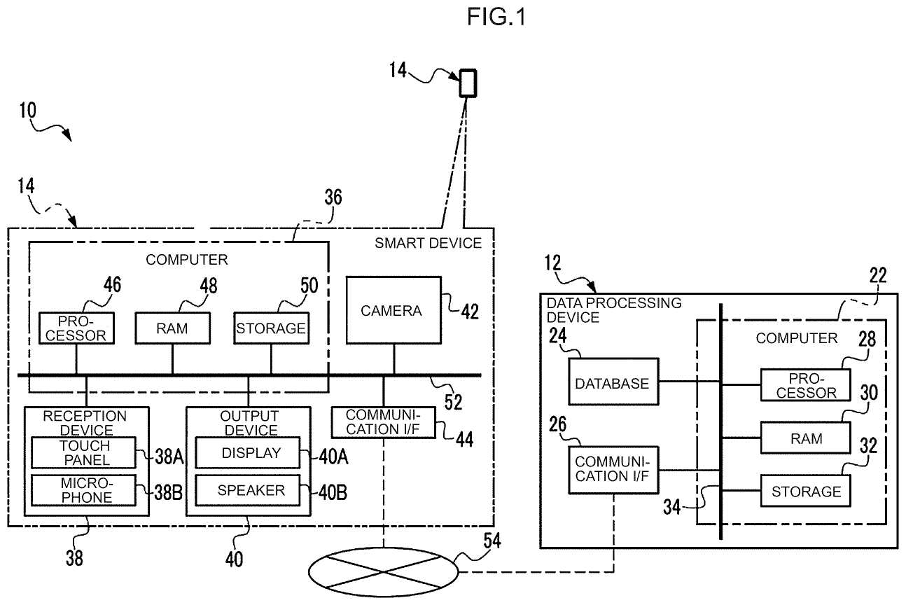

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

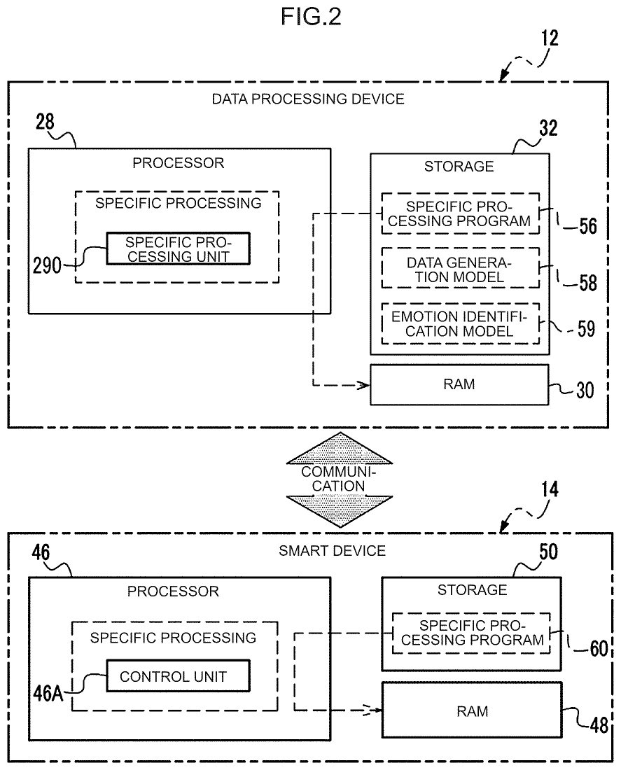

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The card game support system according to the embodiment of the present invention is a system that supports optimal deck building and match practice using AI for users who enjoy card games. This card game support system uses AI to propose an optimal card deck based on the user's personality, preferred style, past deck information, and battle history. Next, it is equipped with a virtual match function against AI, allowing users to try various strategies. Furthermore, it is also equipped with a function in which AI operates the opponent on a virtual battlefield and visually analyzes the strategy. In addition, the system provides a service in which AI analyzes the user's play style and proposes improvements to overcome weaknesses. Furthermore, with IoT functionality for digitizing usage information of physical decks, AI can analyze real-time play data. As a result, the card game support system provides an environment where people who enjoy card games as a hobby can enjoy them even more. For example, users can build decks that match their personality and play style and learn various strategies through matches against AI. In addition, users can improve their play style through improvement proposals provided by AI. Furthermore, by digitizing usage information of physical decks, users can check the performance of their decks in real time and build optimal decks.

The card game support system according to the embodiment includes a proposal unit, a battle unit, an analysis unit, an improvement unit, and a digitization unit. The proposal unit proposes an optimal card deck based on the user's personality, preferred style, past deck information, and battle history. For example, the proposal unit analyzes decks and match results previously used by the user with AI and proposes a deck that matches the user's play style. For example, the proposal unit proposes a deck containing many high-attack cards for users who prefer an aggressive play style. The proposal unit can also propose a deck containing many high-defense cards for users who prefer a defensive play style. Furthermore, the proposal unit can propose a deck with a balance of attack and defense for users who prefer a balanced play style. The battle unit conducts a virtual match against AI using the deck proposed by the proposal unit. For example, the battle unit allows the user to practice in an environment close to an actual match by playing against AI. The battle unit allows the user to learn how to respond to various strategies by having the AI operate the opponent using different strategies. For example, when the AI takes an aggressive strategy, the user can try a defensive strategy. When the AI takes a defensive strategy, the user can try an aggressive strategy. Furthermore, when the AI takes a balanced strategy, the user can try various strategies. The analysis unit visually analyzes the results of the match conducted by the battle unit. For example, the analysis unit is equipped with a function in which AI operates the opponent on a virtual battlefield and visually analyzes the strategy. The analysis unit allows the user to visually check the movements of the opponent operated by AI and understand the strategy. For example, the analysis unit visually shows the timing and order in which the AI uses specific cards, allowing the user to learn the strategy. The analysis unit can also visually show the effects of strategies used by the AI during the match. For example, the analysis unit can display the effects of cards used by the AI in graphs or heat maps. The improvement unit proposes improvements to the play style based on the results obtained by the analysis unit. For example, the improvement unit analyzes mistakes and points for improvement made by the user during the match with AI and provides specific advice. The improvement unit can improve the user's play style by proposing the timing for using specific cards or changes in strategy. For example, the improvement unit proposes improvements to the timing of using specific cards. The improvement unit can also propose changes to specific strategies. Furthermore, the improvement unit can propose trying new strategies. The digitization unit digitizes usage information of physical decks. For example, the digitization unit collects information on physical decks actually used by the user with sensors and AI analyzes the data. The digitization unit allows the user to check the performance of the deck in real time and adjust the deck as necessary. For example, the digitization unit digitizes the types and usage frequency of cards used by the user, and AI evaluates the performance of the deck based on the data. As a result, the card game support system according to the embodiment can propose an optimal deck based on the user's personality and play style, allow the user to learn strategies through matches against AI, and improve the play style.

The proposal unit proposes an optimal card deck based on the user's personality, preferred style, past deck information, and battle history. For example, the proposal unit analyzes decks and match results previously used by the user with AI and proposes a deck that matches the user's play style. Specifically, the AI analyzes the user's past match data in detail, analyzing win rates, frequently used cards, and responses to opponents'strategies. This allows the system to understand which cards the user prefers and what strategies the user excels at. For example, the proposal unit proposes a deck containing many high-attack cards for users who prefer an aggressive play style. In this case, the AI selects combinations of high-attack cards and cards suitable for aggressive strategies. The proposal unit can also propose a deck containing many high-defense cards for users who prefer a defensive play style. In this case, the AI proposes combinations of high-defense cards and cards that effectively block the opponent's attacks. Furthermore, the proposal unit can propose a deck with a balance of attack and defense for users who prefer a balanced play style. The AI considers the balance between attack and defense and builds a deck that allows the user to respond to various situations. When making these proposals, the proposal unit can collect user feedback and continuously improve the proposals. For example, the AI analyzes the results of the user using the proposed deck and uses the results to make more accurate proposals next time. The proposal unit can also propose optimal deck compositions when the user adds new cards or changes existing cards. As a result, the proposal unit can propose the optimal deck according to the user's play style and preferences, thereby improving the user's game experience.

The battle unit conducts a virtual match against AI using the deck proposed by the proposal unit. For example, the battle unit allows the user to practice in an environment close to an actual match by playing against AI. Specifically, the battle unit uses advanced AI algorithms to generate virtual opponents with various strategies. The AI uses different strategies such as aggressive, defensive, and balanced types to provide the user with diverse match scenarios. For example, when the AI takes an aggressive strategy, the user can try a defensive strategy. In this case, the AI actively uses high-attack cards to put pressure on the user. When the AI takes a defensive strategy, the user can try an aggressive strategy. In this case, the AI uses high-defense cards to effectively block the user's attacks. Furthermore, when the AI takes a balanced strategy, the user can try various strategies. The AI balances attack and defense and requires the user to respond in various ways. Through these match scenarios, the battle unit allows the user to develop the ability to respond to different strategies. The battle unit also records match results in real time, allowing the user to check their play style and the effectiveness of their strategies. As a result, the battle unit allows the user to practice in an environment close to an actual match and refine their strategies. The battle unit also records the choices and actions taken by the user during the match so that the analysis unit and improvement unit can utilize the data later. As a result, the battle unit supports the improvement of the user's skills and enhances the game experience.

The analysis unit visually analyzes the results of the match conducted by the battle unit. For example, the analysis unit is equipped with a function in which AI operates the opponent on a virtual battlefield and visually analyzes the strategy. Specifically, the analysis unit analyzes each phase of the match in detail, visually showing when the user used which card and how the AI responded. For example, the analysis unit visually shows the timing and order in which the AI uses specific cards, allowing the user to learn the strategy. This allows the user to understand the AI's strategy and incorporate it into their own play style. The analysis unit can also visually show the effects of strategies used by the AI during the match. For example, the analysis unit can display the effects of cards used by the AI in graphs or heat maps. This allows the user to intuitively understand how specific cards and strategies affected the match results. Furthermore, the analysis unit statistically analyzes match results to clarify the user's strengths and weaknesses. For example, by showing the user's success rate when using specific cards or win rate against specific strategies, the user can objectively evaluate their play style. The analysis unit provides these visual analysis results to the user so that the user can obtain specific guidelines for improving their play style. As a result, the analysis unit allows the user to analyze match results in detail, learn strategies, and improve their play style.

The improvement unit proposes improvements to the play style based on the results obtained by the analysis unit. For example, the improvement unit analyzes mistakes and points for improvement made by the user during the match with AI and provides specific advice. Specifically, the improvement unit analyzes the user's match data in detail and indicates when the user should have used which card and which strategies would have been more effective. For example, the improvement unit proposes improvements to the timing of using specific cards. The AI analyzes the optimal timing for using specific cards based on past match data and provides the results to the user. The improvement unit can also propose changes to specific strategies. For example, if the user took an aggressive strategy when a defensive strategy should have been taken, the AI shows how that choice affected the match result and proposes improvements for the next match. Furthermore, the improvement unit can propose trying new strategies. The AI proposes new strategies and card combinations based on the user's play style and preferences, providing opportunities for the user to try new strategies. Through these proposals, the improvement unit enables the user to continuously improve their play style and enhance their match skills. The improvement unit can also collect user feedback and continuously improve the proposals. As a result, the improvement unit provides specific advice for improving the user's play style and enhances the game experience.

The digitization unit digitizes usage information of physical decks. For example, the digitization unit collects information on physical decks actually used by the user with sensors and AI analyzes the data. Specifically, the digitization unit uses sensors that read RFID tags or barcodes embedded in cards to collect in real time the types and usage frequency of cards used by the user. This allows the system to record in detail which cards the user used at what timing and which cards were most effective. For example, the digitization unit digitizes the types and usage frequency of cards used by the user, and AI evaluates the performance of the deck based on the data. The AI analyzes the collected data and clarifies the strengths and weaknesses of the user's deck. The digitization unit also allows the user to check the performance of the deck in real time and adjust the deck as necessary. For example, when the user wants to check the effect of a specific card during a match or review the balance of the deck, the digitization unit can immediately provide the information. Furthermore, the digitization unit enables the user to seamlessly link physical decks and digital decks. As a result, the user can enjoy the convenience of digital decks while using physical decks. Through these functions, the digitization unit enables the user to effectively utilize both physical and digital decks and enhance the game experience.

The proposal unit can analyze data of the user's past opponents and propose a deck effective against a specific opponent. For example, the proposal unit analyzes the deck composition of opponents the user has played against in the past and proposes a deck containing cards effective against those opponents. If the user has struggled against a specific opponent, the proposal unit can also propose a deck to break that opponent's strategy. The proposal unit can also propose a deck that adopts a similar strategy to the decks of opponents the user has defeated in the past. By proposing a deck effective against a specific opponent, the win rate of matches can be improved. Some or all of the above processing in the proposal unit may be performed using AI or without using AI. For example, the proposal unit can input the user's past opponent data into a generative AI and have the generative AI generate proposals for decks effective against specific opponents.

The proposal unit can adjust the difficulty of the deck based on the user's current in-game rank or score. For example, if the user is a beginner, the proposal unit proposes a deck containing many basic cards. If the user is an intermediate player, the proposal unit can also propose a deck containing many strategic cards. If the user is an advanced player, the proposal unit can also propose a deck containing complex combos. By proposing a deck according to the user's rank or score, a deck of appropriate difficulty can be provided. Some or all of the above processing in the proposal unit may be performed using AI or without using AI. For example, the proposal unit can input the user's in-game rank or score into a generative AI and have the generative AI adjust the difficulty of the deck.

The proposal unit can propose a deck reflecting region-specific strategies by taking into account the user's geographic location information. For example, if the user lives in a cold region, the proposal unit proposes a deck containing many ice-attribute cards. If the user lives in a tropical region, the proposal unit can also propose a deck containing many fire-attribute cards. If the user lives in an urban area, the proposal unit can also propose a deck containing many machine-attribute cards. By proposing a deck reflecting region-specific strategies, a deck suitable for the user can be provided. Some or all of the above processing in the proposal unit may be performed using AI or without using AI. For example, the proposal unit can input the user's geographic location information into a generative AI and have the generative AI generate proposals for decks reflecting region-specific strategies.

The proposal unit can analyze the user's social media activity and propose a deck reflecting relevant trends. For example, the proposal unit proposes a deck containing many cards that are trending on the user's social media. The proposal unit can also propose a deck based on the decks used by influencers followed by the user. The proposal unit can also propose a deck containing many cards popular in communities the user participates in. By proposing a deck reflecting social media trends, the user can be provided with the latest decks. Some or all of the above processing in the proposal unit may be performed using AI or without using AI. For example, the proposal unit can input the user's social media activity data into a generative AI and have the generative AI generate proposals for decks reflecting trends.

The battle unit can refer to the user's past match history and strengthen countermeasures against specific strategies. For example, the battle unit sets up AI with enhanced countermeasures against strategies the user has struggled with in the past. The battle unit can also set up AI that adopts similar strategies to those the user has defeated in the past. The battle unit can also analyze strategies the user has used in the past and set up AI with enhanced countermeasures against those strategies. By referring to past match history, countermeasures against specific strategies can be strengthened. Some or all of the above processing in the battle unit may be performed using AI or without using AI. For example, the battle unit can input the user's past match history data into a generative AI and have the generative AI strengthen countermeasures against specific strategies.

The battle unit can dynamically change the AI's strategy according to the user's play style. For example, if the user adopts an aggressive play style, the AI adopts a defense-oriented strategy. If the user adopts a defensive play style, the AI can also adopt an attack-oriented strategy. If the user adopts a balanced play style, the AI can also flexibly change its strategy. By providing strategies according to the user's play style, more effective matches can be realized. Some or all of the above processing in the battle unit may be performed using AI or without using AI. For example, the battle unit can input the user's play style data into a generative AI and have the generative AI dynamically change the AI's strategy.

The battle unit can conduct matches reflecting region-specific strategies by taking into account the user's geographic location information. For example, if the user lives in a cold region, the battle unit sets up AI that uses many ice-attribute cards. If the user lives in a tropical region, the battle unit can also set up AI that uses many fire-attribute cards. If the user lives in an urban area, the battle unit can also set up AI that uses many machine-attribute cards. By providing matches reflecting region-specific strategies, a match environment suitable for the user can be provided. Some or all of the above processing in the battle unit may be performed using AI or without using AI. For example, the battle unit can input the user's geographic location information into a generative AI and have the generative AI set up matches reflecting region-specific strategies.

The battle unit can analyze the user's social media activity and conduct matches reflecting relevant trends. For example, the battle unit sets up AI that uses many cards trending on the user's social media. The battle unit can also set up AI based on decks used by influencers followed by the user. The battle unit can also set up AI that uses many cards popular in communities the user participates in. By providing matches reflecting social media trends, the user can be provided with the latest match environment. Some or all of the above processing in the battle unit may be performed using AI or without using AI. For example, the battle unit can input the user's social media activity data into a generative AI and have the generative AI set up matches reflecting trends.

The analysis unit can refer to the user's past match data and analyze the effectiveness of specific strategies in detail. For example, the analysis unit analyzes the win rate of strategies used by the user in the past and evaluates their effectiveness. The analysis unit can also analyze the strategies of opponents the user has played against in the past and evaluate their effectiveness. The analysis unit can also analyze combinations of cards used by the user in the past and evaluate their effectiveness. By referring to past match data, the effectiveness of specific strategies can be analyzed in detail. Some or all of the above processing in the analysis unit may be performed using AI or without using AI. For example, the analysis unit can input the user's past match data into a generative AI and have the generative AI perform detailed analysis of the effectiveness of specific strategies.

The analysis unit can apply different analysis algorithms according to the user's play style. For example, if the user adopts an aggressive play style, the analysis unit applies an attack-oriented analysis algorithm. If the user adopts a defensive play style, the analysis unit can also apply a defense-oriented analysis algorithm. If the user adopts a balanced play style, the analysis unit can also apply a balance-oriented analysis algorithm. By providing analysis according to the user's play style, more effective analysis results can be provided. Some or all of the above processing in the analysis unit may be performed using AI or without using AI. For example, the analysis unit can input the user's play style data into a generative AI and have the generative AI apply different analysis algorithms.

The analysis unit can conduct analysis reflecting region-specific strategies by taking into account the user's geographic location information. For example, if the user lives in a cold region, the analysis unit analyzes the effects of ice-attribute cards. If the user lives in a tropical region, the analysis unit can also analyze the effects of fire-attribute cards. If the user lives in an urban area, the analysis unit can also analyze the effects of machine-attribute cards. By providing analysis reflecting region-specific strategies, analysis results suitable for the user can be provided. Some or all of the above processing in the analysis unit may be performed using AI or without using AI. For example, the analysis unit can input the user's geographic location information into a generative AI and have the generative AI perform analysis reflecting region-specific strategies.

The analysis unit can analyze the user's social media activity and conduct analysis reflecting relevant trends. For example, the analysis unit analyzes the effects of cards trending on the user's social media. The analysis unit can also analyze the effects of cards used by influencers followed by the user. The analysis unit can also analyze the effects of cards popular in communities the user participates in. By providing analysis reflecting social media trends, the user can be provided with the latest analysis results. Some or all of the above processing in the analysis unit may be performed using AI or without using AI. For example, the analysis unit can input the user's social media activity data into a generative AI and have the generative AI perform analysis reflecting trends.

The improvement unit can refer to the user's past match data and propose specific improvement measures for particular weaknesses. For example, the improvement unit proposes improvement measures for strategies the user has struggled with in the past. The improvement unit can also analyze mistakes made by the user in the past and propose improvement measures. The improvement unit can also analyze the effects of cards used by the user in the past and propose improvement measures. By referring to past match data, specific improvement measures for particular weaknesses can be provided. Some or all of the above processing in the improvement unit may be performed using AI or without using AI. For example, the improvement unit can input the user's past match data into a generative AI and have the generative AI propose specific improvement measures for particular weaknesses.

The improvement unit can apply different improvement algorithms according to the user's play style. For example, if the user adopts an aggressive play style, the improvement unit proposes attack-oriented improvement measures. If the user adopts a defensive play style, the improvement unit can also propose defense-oriented improvement measures. If the user adopts a balanced play style, the improvement unit can also propose balance-oriented improvement measures. By providing improvement measures according to the user's play style, more effective improvements can be realized. Some or all of the above processing in the improvement unit may be performed using AI or without using AI. For example, the improvement unit can input the user's play style data into a generative AI and have the generative AI apply different improvement algorithms.

The improvement unit can propose improvement measures reflecting region-specific strategies by taking into account the user's geographic location information. For example, if the user lives in a cold region, the improvement unit proposes improvement measures to enhance the effects of ice-attribute cards. If the user lives in a tropical region, the improvement unit can also propose improvement measures to enhance the effects of fire-attribute cards. If the user lives in an urban area, the improvement unit can also propose improvement measures to enhance the effects of machine-attribute cards. By providing improvement measures reflecting region-specific strategies, improvement measures suitable for the user can be provided. Some or all of the above processing in the improvement unit may be performed using AI or without using AI. For example, the improvement unit can input the user's geographic location information into a generative AI and have the generative AI propose improvement measures reflecting region-specific strategies.

The improvement unit can analyze the user's social media activity and propose improvement measures reflecting relevant trends. For example, the improvement unit proposes improvement measures to enhance the effects of cards trending on the user's social media. The improvement unit can also propose improvement measures to enhance the effects of cards used by influencers followed by the user. The improvement unit can also propose improvement measures to enhance the effects of cards popular in communities the user participates in. By providing improvement measures reflecting social media trends, the user can be provided with the latest improvement measures. Some or all of the above processing in the improvement unit may be performed using AI or without using AI. For example, the improvement unit can input the user's social media activity data into a generative AI and have the generative AI propose improvement measures reflecting trends.

The digitization unit can refer to the user's past deck usage data and record the usage frequency of specific cards in detail. For example, the digitization unit records the usage frequency of cards frequently used by the user in the past. The digitization unit can also record the effects of cards used by the user in the past. The digitization unit can also record combinations of cards used by the user in the past. By referring to past deck usage data, the usage frequency of specific cards can be recorded in detail. Some or all of the above processing in the digitization unit may be performed using AI or without using AI. For example, the digitization unit can input the user's past deck usage data into a generative AI and have the generative AI record the detailed usage frequency of specific cards.

The digitization unit can apply different digitization algorithms according to the user's play style. For example, if the user adopts an aggressive play style, the digitization unit applies an attack-oriented digitization algorithm. If the user adopts a defensive play style, the digitization unit can also apply a defense-oriented digitization algorithm. If the user adopts a balanced play style, the digitization unit can also apply a balance-oriented digitization algorithm. By providing digitization according to the user's play style, more effective data can be provided. Some or all of the above processing in the digitization unit may be performed using AI or without using AI. For example, the digitization unit can input the user's play style data into a generative AI and have the generative AI apply different digitization algorithms.

The digitization unit can prioritize digitization of region-specific data by taking into account the user's geographic location information. For example, if the user lives in a cold region, the digitization unit prioritizes digitization of data for ice-attribute cards. If the user lives in a tropical region, the digitization unit can also prioritize digitization of data for fire-attribute cards. If the user lives in an urban area, the digitization unit can also prioritize digitization of data for machine-attribute cards. By prioritizing digitization of region-specific data, data suitable for the user can be provided. Some or all of the above processing in the digitization unit may be performed using AI or without using AI. For example, the digitization unit can input the user's geographic location information into a generative AI and have the generative AI prioritize digitization of region-specific data.

The digitization unit can analyze the user's social media activity and digitize data reflecting relevant trends. For example, the digitization unit digitizes data for cards trending on the user's social media. The digitization unit can also digitize data for cards used by influencers followed by the user. The digitization unit can also digitize data for cards popular in communities the user participates in. By digitizing data reflecting social media trends, the user can be provided with the latest data. Some or all of the above processing in the digitization unit may be performed using AI or without using AI. For example, the digitization unit can input the user's social media activity data into a generative AI and have the generative AI digitize data reflecting trends.

The digitization unit can prioritize digitization of optimal data by taking into account the user's health condition. For example, if the user is tired, the digitization unit prioritizes important data. If the user is healthy, the digitization unit can also prioritize detailed data. If the user is in poor physical condition, the digitization unit can also prioritize essential data. By prioritizing digitization of data according to the user's health condition, appropriate data can be provided. Some or all of the above processing in the digitization unit may be performed using AI or without using AI. For example, the digitization unit can input the user's health condition data into a generative AI and have the generative AI prioritize digitization of data based on health condition.

The system according to the embodiment is not limited to the above examples and, for example, various modifications are possible as described below.

The proposal unit can analyze data of the user's past opponents and propose a deck effective against a specific opponent. For example, the proposal unit analyzes the deck composition of opponents the user has played against in the past and proposes a deck containing cards effective against those opponents. If the user has struggled against a specific opponent, the proposal unit can also propose a deck to break that opponent's strategy. The proposal unit can also propose a deck that adopts a similar strategy to the decks of opponents the user has defeated in the past. By proposing a deck effective against a specific opponent, the win rate of matches can be improved. Some or all of the above processing in the proposal unit may be performed using AI or without using AI. For example, the proposal unit can input the user's past opponent data into a generative AI and have the generative AI generate proposals for decks effective against specific opponents.

The proposal unit can adjust the difficulty of the deck based on the user's current in-game rank or score. For example, if the user is a beginner, the proposal unit proposes a deck containing many basic cards. If the user is an intermediate player, the proposal unit can also propose a deck containing many strategic cards. If the user is an advanced player, the proposal unit can also propose a deck containing complex combos. By proposing a deck according to the user's rank or score, a deck of appropriate difficulty can be provided. Some or all of the above processing in the proposal unit may be performed using AI or without using AI. For example, the proposal unit can input the user's in-game rank or score into a generative AI and have the generative AI adjust the difficulty of the deck.

The proposal unit can propose a deck reflecting region-specific strategies by taking into account the user's geographic location information. For example, if the user lives in a cold region, the proposal unit proposes a deck containing many ice-attribute cards. If the user lives in a tropical region, the proposal unit can also propose a deck containing many fire-attribute cards. If the user lives in an urban area, the proposal unit can also propose a deck containing many machine-attribute cards. By proposing a deck reflecting region-specific strategies, a deck suitable for the user can be provided. Some or all of the above processing in the proposal unit may be performed using AI or without using AI. For example, the proposal unit can input the user's geographic location information into a generative AI and have the generative AI generate proposals for decks reflecting region-specific strategies.

The proposal unit can analyze the user's social media activity and propose a deck reflecting relevant trends. For example, the proposal unit proposes a deck containing many cards that are trending on the user's social media. The proposal unit can also propose a deck based on the decks used by influencers followed by the user. The proposal unit can also propose a deck containing many cards popular in communities the user participates in. By proposing a deck reflecting social media trends, the user can be provided with the latest decks. Some or all of the above processing in the proposal unit may be performed using AI or without using AI. For example, the proposal unit can input the user's social media activity data into a generative AI and have the generative AI generate proposals for decks reflecting trends.

The battle unit can refer to the user's past match history and strengthen countermeasures against specific strategies. For example, the battle unit sets up AI with enhanced countermeasures against strategies the user has struggled with in the past. The battle unit can also set up AI that adopts similar strategies to those the user has defeated in the past. The battle unit can also analyze strategies the user has used in the past and set up AI with enhanced countermeasures against those strategies. By referring to past match history, countermeasures against specific strategies can be strengthened. Some or all of the above processing in the battle unit may be performed using AI or without using AI. For example, the battle unit can input the user's past match history data into a generative AI and have the generative AI strengthen countermeasures against specific strategies.

The battle unit can dynamically change the AI's strategy according to the user's play style. For example, if the user adopts an aggressive play style, the AI adopts a defense-oriented strategy. If the user adopts a defensive play style, the AI can also adopt an attack-oriented strategy. If the user adopts a balanced play style, the AI can also flexibly change its strategy. By providing strategies according to the user's play style, more effective matches can be realized. Some or all of the above processing in the battle unit may be performed using AI or without using AI. For example, the battle unit can input the user's play style data into a generative AI and have the generative AI dynamically change the AI's strategy.

The following is a brief description of the processing flow of Example 1 of the Embodiment.

Step 1: The proposal unit proposes an optimal card deck based on the user's personality, preferred style, past deck information, and battle history. For example, the proposal unit analyzes decks and match results previously used by the user with AI and proposes a deck that matches the user's play style. For users who prefer an aggressive play style, a deck containing many high-attack cards is proposed; for users who prefer a defensive play style, a deck containing many high-defense cards is proposed; and for users who prefer a balanced play style, a deck with a balance of attack and defense is proposed.

Step 2: The battle unit conducts a virtual match against AI using the deck proposed by the proposal unit. For example, by playing against AI, the user can practice in an environment close to an actual match. The battle unit allows the user to learn how to respond to various strategies by having the AI operate the opponent using different strategies. When the AI takes an aggressive strategy, the user can try a defensive strategy, and when the AI takes a defensive strategy, the user can try an aggressive strategy. Furthermore, when the AI takes a balanced strategy, the user can try various strategies.

Step 3: The analysis unit visually analyzes the results of the match conducted by the battle unit. For example, the system is equipped with a function in which AI operates the opponent on a virtual battlefield and visually analyzes the strategy. The user can visually check the movements of the opponent operated by AI and understand the strategy. By visually showing the timing and order in which the AI uses specific cards, the user can learn the strategy. The system can also visually show the effects of strategies used by the AI during the match. For example, the effects of cards used by the AI can be displayed in graphs or heat maps.

Step 4: The improvement unit proposes improvements to the play style based on the results obtained by the analysis unit. For example, the AI analyzes mistakes and points for improvement made by the user during the match and provides specific advice. By proposing improvements to the timing of using specific cards or changes in strategy, the user's play style can be improved. The system can propose improvements to the timing of using specific cards, changes to specific strategies, and trying new strategies.

Step 5: The digitization unit digitizes usage information of physical decks. For example, the system collects information on physical decks actually used by the user with sensors and AI analyzes the data. The user can check the performance of the deck in real time and adjust the deck as necessary. The system digitizes the types and usage frequency of cards used by the user, and AI evaluates the performance of the deck based on the data.

### Example 2 of Embodiment

The card game support system according to the embodiment of the present invention is a system that supports optimal deck building and match practice using AI for users who enjoy card games. This card game support system uses AI to propose an optimal card deck based on the user's personality, preferred style, past deck information, and battle history. Next, it is equipped with a virtual match function against AI, allowing users to try various strategies. Furthermore, it is also equipped with a function in which AI operates the opponent on a virtual battlefield and visually analyzes the strategy. In addition, the system provides a service in which AI analyzes the user's play style and proposes improvements to overcome weaknesses. Furthermore, with IoT functionality for digitizing usage information of physical decks, AI can analyze real-time play data. As a result, the card game support system provides an environment where people who enjoy card games as a hobby can enjoy them even more. For example, users can build decks that match their personality and play style and learn various strategies through matches against AI. In addition, users can improve their play style through improvement proposals provided by AI. Furthermore, by digitizing usage information of physical decks, users can check the performance of their decks in real time and build optimal decks.

The card game support system according to the embodiment includes a proposal unit, a battle unit, an analysis unit, an improvement unit, and a digitization unit. The proposal unit proposes an optimal card deck based on the user's personality, preferred style, past deck information, and battle history. For example, the proposal unit analyzes decks and match results previously used by the user with AI and proposes a deck that matches the user's play style. For example, the proposal unit proposes a deck containing many high-attack cards for users who prefer an aggressive play style. The proposal unit can also propose a deck containing many high-defense cards for users who prefer a defensive play style. Furthermore, the proposal unit can propose a deck with a balance of attack and defense for users who prefer a balanced play style. The battle unit conducts a virtual match against AI using the deck proposed by the proposal unit. For example, the battle unit allows the user to practice in an environment close to an actual match by playing against AI. The battle unit allows the user to learn how to respond to various strategies by having the AI operate the opponent using different strategies. For example, when the AI takes an aggressive strategy, the user can try a defensive strategy. When the AI takes a defensive strategy, the user can try an aggressive strategy. Furthermore, when the AI takes a balanced strategy, the user can try various strategies. The analysis unit visually analyzes the results of the match conducted by the battle unit. For example, the analysis unit is equipped with a function in which AI operates the opponent on a virtual battlefield and visually analyzes the strategy. The analysis unit allows the user to visually check the movements of the opponent operated by AI and understand the strategy. For example, the analysis unit visually shows the timing and order in which the AI uses specific cards, allowing the user to learn the strategy. The analysis unit can also visually show the effects of strategies used by the AI during the match. For example, the analysis unit can display the effects of cards used by the AI in graphs or heat maps. The improvement unit proposes improvements to the play style based on the results obtained by the analysis unit. For example, the improvement unit analyzes mistakes and points for improvement made by the user during the match with AI and provides specific advice. The improvement unit can improve the user's play style by proposing the timing for using specific cards or changes in strategy. For example, the improvement unit proposes improvements to the timing of using specific cards. The improvement unit can also propose changes to specific strategies. Furthermore, the improvement unit can propose trying new strategies. The digitization unit digitizes usage information of physical decks. For example, the digitization unit collects information on physical decks actually used by the user with sensors and AI analyzes the data. The digitization unit allows the user to check the performance of the deck in real time and adjust the deck as necessary. For example, the digitization unit digitizes the types and usage frequency of cards used by the user, and AI evaluates the performance of the deck based on the data. As a result, the card game support system according to the embodiment can propose an optimal deck based on the user's personality and play style, allow the user to learn strategies through matches against AI, and improve the play style.

The proposal unit proposes an optimal card deck based on the user's personality, preferred style, past deck information, and battle history. For example, the proposal unit analyzes decks and match results previously used by the user with AI and proposes a deck that matches the user's play style. Specifically, the AI analyzes the user's past match data in detail, analyzing win rates, frequently used cards, and responses to opponents'strategies. This allows the system to understand which cards the user prefers and what strategies the user excels at. For example, the proposal unit proposes a deck containing many high-attack cards for users who prefer an aggressive play style. In this case, the AI selects combinations of high-attack cards and cards suitable for aggressive strategies. The proposal unit can also propose a deck containing many high-defense cards for users who prefer a defensive play style. In this case, the AI proposes combinations of high-defense cards and cards that effectively block the opponent's attacks. Furthermore, the proposal unit can propose a deck with a balance of attack and defense for users who prefer a balanced play style. The AI considers the balance between attack and defense and builds a deck that allows the user to respond to various situations. When making these proposals, the proposal unit can collect user feedback and continuously improve the proposals. For example, the AI analyzes the results of the user using the proposed deck and uses the results to make more accurate proposals next time. The proposal unit can also propose optimal deck compositions when the user adds new cards or changes existing cards. As a result, the proposal unit can propose the optimal deck according to the user's play style and preferences, thereby improving the user's game experience.

The battle unit conducts a virtual match against AI using the deck proposed by the proposal unit. For example, the battle unit allows the user to practice in an environment close to an actual match by playing against AI. Specifically, the battle unit uses advanced AI algorithms to generate virtual opponents with various strategies. The AI uses different strategies such as aggressive, defensive, and balanced types to provide the user with diverse match scenarios. For example, when the AI takes an aggressive strategy, the user can try a defensive strategy. In this case, the AI actively uses high-attack cards to put pressure on the user. When the AI takes a defensive strategy, the user can try an aggressive strategy. In this case, the AI uses high-defense cards to effectively block the user's attacks. Furthermore, when the AI takes a balanced strategy, the user can try various strategies. The AI balances attack and defense and requires the user to respond in various ways. Through these match scenarios, the battle unit allows the user to develop the ability to respond to different strategies. The battle unit also records match results in real time, allowing the user to check their play style and the effectiveness of their strategies. As a result, the battle unit allows the user to practice in an environment close to an actual match and refine their strategies. The battle unit also records the choices and actions taken by the user during the match so that the analysis unit and improvement unit can utilize the data later. As a result, the battle unit supports the improvement of the user's skills and enhances the game experience.

The analysis unit visually analyzes the results of the match conducted by the battle unit. For example, the analysis unit is equipped with a function in which AI operates the opponent on a virtual battlefield and visually analyzes the strategy. Specifically, the analysis unit analyzes each phase of the match in detail, visually showing when the user used which card and how the AI responded. For example, the analysis unit visually shows the timing and order in which the AI uses specific cards, allowing the user to learn the strategy. This allows the user to understand the AI's strategy and incorporate it into their own play style. The analysis unit can also visually show the effects of strategies used by the AI during the match. For example, the analysis unit can display the effects of cards used by the AI in graphs or heat maps. This allows the user to intuitively understand how specific cards and strategies affected the match results. Furthermore, the analysis unit statistically analyzes match results to clarify the user's strengths and weaknesses. For example, by showing the user's success rate when using specific cards or win rate against specific strategies, the user can objectively evaluate their play style. The analysis unit provides these visual analysis results to the user so that the user can obtain specific guidelines for improving their play style. As a result, the analysis unit allows the user to analyze match results in detail, learn strategies, and improve their play style.

The improvement unit proposes improvements to the play style based on the results obtained by the analysis unit. For example, the improvement unit analyzes mistakes and points for improvement made by the user during the match with AI and provides specific advice. Specifically, the improvement unit analyzes the user's match data in detail and indicates when the user should have used which card and which strategies would have been more effective. For example, the improvement unit proposes improvements to the timing of using specific cards. The AI analyzes the optimal timing for using specific cards based on past match data and provides the results to the user. The improvement unit can also propose changes to specific strategies. For example, if the user took an aggressive strategy when a defensive strategy should have been taken, the AI shows how that choice affected the match result and proposes improvements for the next match. Furthermore, the improvement unit can propose trying new strategies. The AI proposes new strategies and card combinations based on the user's play style and preferences, providing opportunities for the user to try new strategies. Through these proposals, the improvement unit enables the user to continuously improve their play style and enhance their match skills. The improvement unit can also collect user feedback and continuously improve the proposals. As a result, the improvement unit provides specific advice for improving the user's play style and enhances the game experience.

The digitization unit digitizes usage information of physical decks. For example, the digitization unit collects information on physical decks actually used by the user with sensors and AI analyzes the data. Specifically, the digitization unit uses sensors that read RFID tags or barcodes embedded in cards to collect in real time the types and usage frequency of cards used by the user. This allows the system to record in detail which cards the user used at what timing and which cards were most effective. For example, the digitization unit digitizes the types and usage frequency of cards used by the user, and AI evaluates the performance of the deck based on the data. The AI analyzes the collected data and clarifies the strengths and weaknesses of the user's deck. The digitization unit also allows the user to check the performance of the deck in real time and adjust the deck as necessary. For example, when the user wants to check the effect of a specific card during a match or review the balance of the deck, the digitization unit can immediately provide the information. Furthermore, the digitization unit enables the user to seamlessly link physical decks and digital decks. As a result, the user can enjoy the convenience of digital decks while using physical decks. Through these functions, the digitization unit enables the user to effectively utilize both physical and digital decks and enhance the game experience.

The proposal unit can estimate the user's emotions and adjust the type of proposed deck based on the estimated emotions of the user. For example, if the user is feeling stressed, the proposal unit proposes a defense-oriented deck that allows the user to relax. If the user is excited, the proposal unit can also propose a deck containing many aggressive cards. If the user is calm, the proposal unit can also propose a balanced deck. By proposing a deck according to the user's emotions, a more appropriate deck can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the proposal unit may be performed using AI or without using AI. For example, the proposal unit can input the user's emotion data into a generative AI and have the generative AI generate proposals for decks based on emotions.

The proposal unit can analyze data of the user's past opponents and propose a deck effective against a specific opponent. For example, the proposal unit analyzes the deck composition of opponents the user has played against in the past and proposes a deck containing cards effective against those opponents. If the user has struggled against a specific opponent, the proposal unit can also propose a deck to break that opponent's strategy. The proposal unit can also propose a deck that adopts a similar strategy to the decks of opponents the user has defeated in the past. By proposing a deck effective against a specific opponent, the win rate of matches can be improved. Some or all of the above processing in the proposal unit may be performed using AI or without using AI. For example, the proposal unit can input the user's past opponent data into a generative AI and have the generative AI generate proposals for decks effective against specific opponents.

The proposal unit can adjust the difficulty of the deck based on the user's current in-game rank or score. For example, if the user is a beginner, the proposal unit proposes a deck containing many basic cards. If the user is an intermediate player, the proposal unit can also propose a deck containing many strategic cards. If the user is an advanced player, the proposal unit can also propose a deck containing complex combos. By proposing a deck according to the user's rank or score, a deck of appropriate difficulty can be provided. Some or all of the above processing in the proposal unit may be performed using AI or without using AI. For example, the proposal unit can input the user's in-game rank or score into a generative AI and have the generative AI adjust the difficulty of the deck.

The proposal unit can estimate the user's emotions and adjust the order of cards in the proposed deck based on the estimated emotions of the user. For example, if the user is nervous, the proposal unit proposes a deck with many defense cards placed at the beginning. If the user is relaxed, the proposal unit can also propose a deck with many attack cards placed at the beginning. If the user is excited, the proposal unit can also propose a deck with powerful cards placed at the beginning. By proposing the order of cards according to the user's emotions, a more effective deck can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the proposal unit may be performed using AI or without using AI. For example, the proposal unit can input the user's emotion data into a generative AI and have the generative AI adjust the order of cards based on emotions.

The proposal unit can propose a deck reflecting region-specific strategies by taking into account the user's geographic location information. For example, if the user lives in a cold region, the proposal unit proposes a deck containing many ice-attribute cards. If the user lives in a tropical region, the proposal unit can also propose a deck containing many fire-attribute cards. If the user lives in an urban area, the proposal unit can also propose a deck containing many machine-attribute cards. By proposing a deck reflecting region-specific strategies, a deck suitable for the user can be provided. Some or all of the above processing in the proposal unit may be performed using AI or without using AI. For example, the proposal unit can input the user's geographic location information into a generative AI and have the generative AI generate proposals for decks reflecting region-specific strategies.

The proposal unit can analyze the user's social media activity and propose a deck reflecting relevant trends. For example, the proposal unit proposes a deck containing many cards that are trending on the user's social media. The proposal unit can also propose a deck based on the decks used by influencers followed by the user. The proposal unit can also propose a deck containing many cards popular in communities the user participates in. By proposing a deck reflecting social media trends, the user can be provided with the latest decks. Some or all of the above processing in the proposal unit may be performed using AI or without using AI. For example, the proposal unit can input the user's social media activity data into a generative AI and have the generative AI generate proposals for decks reflecting trends.

The battle unit can estimate the user's emotions and adjust the difficulty of the match based on the estimated emotions of the user. For example, if the user is nervous, the battle unit sets the strength of the opponent low. If the user is relaxed, the battle unit can also set the strength of the opponent to a medium level. If the user is excited, the battle unit can also set the strength of the opponent high. By providing matches of difficulty according to the user's emotions, an appropriate match environment can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the battle unit may be performed using AI or without using AI. For example, the battle unit can input the user's emotion data into a generative AI and have the generative AI adjust the difficulty of the match based on emotions.

The battle unit can refer to the user's past match history and strengthen countermeasures against specific strategies. For example, the battle unit sets up AI with enhanced countermeasures against strategies the user has struggled with in the past. The battle unit can also set up AI that adopts similar strategies to those the user has defeated in the past. The battle unit can also analyze strategies the user has used in the past and set up AI with enhanced countermeasures against those strategies. By referring to past match history, countermeasures against specific strategies can be strengthened. Some or all of the above processing in the battle unit may be performed using AI or without using AI. For example, the battle unit can input the user's past match history data into a generative AI and have the generative AI strengthen countermeasures against specific strategies.

The battle unit can dynamically change the AI's strategy according to the user's play style. For example, if the user adopts an aggressive play style, the AI adopts a defense-oriented strategy. If the user adopts a defensive play style, the AI can also adopt an attack-oriented strategy. If the user adopts a balanced play style, the AI can also flexibly change its strategy. By providing strategies according to the user's play style, more effective matches can be realized. Some or all of the above processing in the battle unit may be performed using AI or without using AI. For example, the battle unit can input the user's play style data into a generative AI and have the generative AI dynamically change the AI's strategy.

The battle unit can estimate the user's emotions and adjust the tempo of the match based on the estimated emotions of the user. For example, if the user is nervous, the battle unit slows down the tempo of the match. If the user is relaxed, the battle unit can also set the tempo to normal. If the user is excited, the battle unit can also speed up the tempo of the match. By providing matches with a tempo according to the user's emotions, an appropriate match environment can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the battle unit may be performed using AI or without using AI. For example, the battle unit can input the user's emotion data into a generative AI and have the generative AI adjust the tempo of the match based on emotions.

The battle unit can conduct matches reflecting region-specific strategies by taking into account the user's geographic location information. For example, if the user lives in a cold region, the battle unit sets up AI that uses many ice-attribute cards. If the user lives in a tropical region, the battle unit can also set up AI that uses many fire-attribute cards. If the user lives in an urban area, the battle unit can also set up AI that uses many machine-attribute cards. By providing matches reflecting region-specific strategies, a match environment suitable for the user can be provided. Some or all of the above processing in the battle unit may be performed using AI or without using AI. For example, the battle unit can input the user's geographic location information into a generative AI and have the generative AI set up matches reflecting region-specific strategies.

The battle unit can analyze the user's social media activity and conduct matches reflecting relevant trends. For example, the battle unit sets up AI that uses many cards trending on the user's social media. The battle unit can also set up AI based on decks used by influencers followed by the user. The battle unit can also set up AI that uses many cards popular in communities the user participates in. By providing matches reflecting social media trends, the user can be provided with the latest match environment. Some or all of the above processing in the battle unit may be performed using AI or without using AI. For example, the battle unit can input the user's social media activity data into a generative AI and have the generative AI set up matches reflecting trends.

The analysis unit can estimate the user's emotion and adjust the display method of the analysis result based on the estimated user's emotion. For example, when the user is nervous, the analysis unit provides a simple and highly visible display method. When the user is relaxed, the analysis unit can also provide a display method that includes detailed information. When the user is in a hurry, the analysis unit can also provide a display method that focuses on key points. By providing a display method according to the user's emotion, appropriate analysis results can be provided. The estimation of emotion is realized, for example, by using an emotion estimation function such as an emotion engine or generative AI. The generative AI may be a text generation AI (for example, an LLM) or a multimodal generative AI, but is not limited to such examples. Some or all of the above-described processing in the analysis unit may be performed using AI, or may be performed without using AI. For example, the analysis unit can input the user's emotion data to the generative AI and have the generative AI execute the adjustment of the display method of the analysis result based on the emotion.

The analysis unit can refer to the user's past match data and analyze the effectiveness of specific strategies in detail. For example, the analysis unit analyzes the win rate of strategies used by the user in the past and evaluates their effectiveness. The analysis unit can also analyze the strategies of opponents the user has played against in the past and evaluate their effectiveness. The analysis unit can also analyze combinations of cards used by the user in the past and evaluate their effectiveness. By referring to past match data, the effectiveness of specific strategies can be analyzed in detail. Some or all of the above processing in the analysis unit may be performed using AI or without using AI. For example, the analysis unit can input the user's past match data into a generative AI and have the generative AI perform detailed analysis of the effectiveness of specific strategies.

The analysis unit can apply different analysis algorithms according to the user's play style. For example, if the user adopts an aggressive play style, the analysis unit applies an attack-oriented analysis algorithm. If the user adopts a defensive play style, the analysis unit can also apply a defense-oriented analysis algorithm. If the user adopts a balanced play style, the analysis unit can also apply a balance-oriented analysis algorithm. By providing analysis according to the user's play style, more effective analysis results can be provided. Some or all of the above processing in the analysis unit may be performed using AI or without using AI. For example, the analysis unit can input the user's play style data into a generative AI and have the generative AI apply different analysis algorithms.

The analysis unit can estimate the user's emotions and determine the priority of analysis results based on the estimated emotions of the user. For example, if the user is nervous, the analysis unit prioritizes important information. If the user is relaxed, the analysis unit can also prioritize detailed information. If the user is in a hurry, the analysis unit can also prioritize information that focuses on key points. By providing analysis results with priorities according to the user's emotions, appropriate information can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the analysis unit may be performed using AI or without using AI. For example, the analysis unit can input the user's emotion data into a generative AI and have the generative AI determine the priority of analysis results based on emotions.

The analysis unit can conduct analysis reflecting region-specific strategies by taking into account the user's geographic location information. For example, if the user lives in a cold region, the analysis unit analyzes the effects of ice-attribute cards. If the user lives in a tropical region, the analysis unit can also analyze the effects of fire-attribute cards. If the user lives in an urban area, the analysis unit can also analyze the effects of machine-attribute cards. By providing analysis reflecting region-specific strategies, analysis results suitable for the user can be provided. Some or all of the above processing in the analysis unit may be performed using AI or without using AI. For example, the analysis unit can input the user's geographic location information into a generative AI and have the generative AI perform analysis reflecting region-specific strategies.

The analysis unit can analyze the user's social media activity and conduct analysis reflecting relevant trends. For example, the analysis unit analyzes the effects of cards trending on the user's social media. The analysis unit can also analyze the effects of cards used by influencers followed by the user. The analysis unit can also analyze the effects of cards popular in communities the user participates in. By providing analysis reflecting social media trends, the user can be provided with the latest analysis results. Some or all of the above processing in the analysis unit may be performed using AI or without using AI. For example, the analysis unit can input the user's social media activity data into a generative AI and have the generative AI perform analysis reflecting trends.

The improvement unit can estimate the user's emotions and adjust the content of improvement proposals based on the estimated emotions of the user. For example, if the user is nervous, the improvement unit provides simple and easy-to-implement improvement proposals. If the user is relaxed, the improvement unit can also provide detailed improvement proposals. If the user is excited, the improvement unit can also provide proactive improvement proposals. By providing improvement proposals according to the user's emotions, appropriate improvement measures can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the improvement unit may be performed using AI or without using AI. For example, the improvement unit can input the user's emotion data into a generative AI and have the generative AI adjust the content of improvement proposals based on emotions.

The improvement unit can refer to the user's past match data and propose specific improvement measures for particular weaknesses. For example, the improvement unit proposes improvement measures for strategies the user has struggled with in the past. The improvement unit can also analyze mistakes made by the user in the past and propose improvement measures. The improvement unit can also analyze the effects of cards used by the user in the past and propose improvement measures. By referring to past match data, specific improvement measures for particular weaknesses can be provided. Some or all of the above processing in the improvement unit may be performed using AI or without using AI. For example, the improvement unit can input the user's past match data into a generative AI and have the generative AI propose specific improvement measures for particular weaknesses.

The improvement unit can apply different improvement algorithms according to the user's play style. For example, if the user adopts an aggressive play style, the improvement unit proposes attack-oriented improvement measures. If the user adopts a defensive play style, the improvement unit can also propose defense-oriented improvement measures. If the user adopts a balanced play style, the improvement unit can also propose balance-oriented improvement measures. By providing improvement measures according to the user's play style, more effective improvements can be realized. Some or all of the above processing in the improvement unit may be performed using AI or without using AI. For example, the improvement unit can input the user's play style data into a generative AI and have the generative AI apply different improvement algorithms.

The improvement unit can estimate the user's emotions and determine the priority of improvement proposals based on the estimated emotions of the user. For example, if the user is nervous, the improvement unit prioritizes important improvement measures. If the user is relaxed, the improvement unit can also prioritize detailed improvement measures. If the user is in a hurry, the improvement unit can also prioritize improvement measures that focus on key points. By providing improvement proposals with priorities according to the user's emotions, appropriate improvement measures can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the improvement unit may be performed using AI or without using AI. For example, the improvement unit can input the user's emotion data into a generative AI and have the generative AI determine the priority of improvement proposals based on emotions.

The improvement unit can propose improvement measures reflecting region-specific strategies by taking into account the user's geographic location information. For example, if the user lives in a cold region, the improvement unit proposes improvement measures to enhance the effects of ice-attribute cards. If the user lives in a tropical region, the improvement unit can also propose improvement measures to enhance the effects of fire-attribute cards. If the user lives in an urban area, the improvement unit can also propose improvement measures to enhance the effects of machine-attribute cards. By providing improvement measures reflecting region-specific strategies, improvement measures suitable for the user can be provided. Some or all of the above processing in the improvement unit may be performed using AI or without using AI. For example, the improvement unit can input the user's geographic location information into a generative AI and have the generative AI propose improvement measures reflecting region-specific strategies.

The improvement unit can analyze the user's social media activity and propose improvement measures reflecting relevant trends. For example, the improvement unit proposes improvement measures to enhance the effects of cards trending on the user's social media. The improvement unit can also propose improvement measures to enhance the effects of cards used by influencers followed by the user. The improvement unit can also propose improvement measures to enhance the effects of cards popular in communities the user participates in. By providing improvement measures reflecting social media trends, the user can be provided with the latest improvement measures. Some or all of the above processing in the improvement unit may be performed using AI or without using AI. For example, the improvement unit can input the user's social media activity data into a generative AI and have the generative AI propose improvement measures reflecting trends.

The digitization unit can estimate the user's emotions and adjust the type of data to be digitized based on the estimated emotions of the user. For example, if the user is nervous, the digitization unit prioritizes important data for digitization. If the user is relaxed, the digitization unit can also prioritize detailed data for digitization. If the user is in a hurry, the digitization unit can also prioritize data that focuses on key points for digitization. By providing digitization of data according to the user's emotions, appropriate data can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the digitization unit may be performed using AI or without using AI. For example, the digitization unit can input the user's emotion data into a generative AI and have the generative AI adjust the digitization of data based on emotions.

The digitization unit can refer to the user's past deck usage data and record the usage frequency of specific cards in detail. For example, the digitization unit records the usage frequency of cards frequently used by the user in the past. The digitization unit can also record the effects of cards used by the user in the past. The digitization unit can also record combinations of cards used by the user in the past. By referring to past deck usage data, the usage frequency of specific cards can be recorded in detail. Some or all of the above processing in the digitization unit may be performed using AI or without using AI. For example, the digitization unit can input the user's past deck usage data into a generative AI and have the generative AI record the detailed usage frequency of specific cards.

The digitization unit can apply different digitization algorithms according to the user's play style. For example, if the user adopts an aggressive play style, the digitization unit applies an attack-oriented digitization algorithm. If the user adopts a defensive play style, the digitization unit can also apply a defense-oriented digitization algorithm. If the user adopts a balanced play style, the digitization unit can also apply a balance-oriented digitization algorithm. By providing digitization according to the user's play style, more effective data can be provided. Some or all of the above processing in the digitization unit may be performed using AI or without using AI. For example, the digitization unit can input the user's play style data into a generative AI and have the generative AI apply different digitization algorithms.

The digitization unit can estimate the user's emotions and determine the priority of data to be digitized based on the estimated emotions of the user. For example, if the user is nervous, the digitization unit prioritizes important data for digitization. If the user is relaxed, the digitization unit can also prioritize detailed data for digitization. If the user is in a hurry, the digitization unit can also prioritize data that focuses on key points for digitization. By digitizing data with priorities according to the user's emotions, appropriate data can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the digitization unit may be performed using AI or without using AI. For example, the digitization unit can input the user's emotion data into a generative AI and have the generative AI determine the priority of data to be digitized based on emotions.

The digitization unit can prioritize digitization of region-specific data by taking into account the user's geographic location information. For example, if the user lives in a cold region, the digitization unit prioritizes digitization of data for ice-attribute cards. If the user lives in a tropical region, the digitization unit can also prioritize digitization of data for fire-attribute cards. If the user lives in an urban area, the digitization unit can also prioritize digitization of data for machine-attribute cards. By prioritizing digitization of region-specific data, data suitable for the user can be provided. Some or all of the above processing in the digitization unit may be performed using AI or without using AI. For example, the digitization unit can input the user's geographic location information into a generative AI and have the generative AI prioritize digitization of region-specific data.

The digitization unit can analyze the user's social media activity and digitize data reflecting relevant trends. For example, the digitization unit digitizes data for cards trending on the user's social media. The digitization unit can also digitize data for cards used by influencers followed by the user. The digitization unit can also digitize data for cards popular in communities the user participates in. By digitizing data reflecting social media trends, the user can be provided with the latest data. Some or all of the above processing in the digitization unit may be performed using AI or without using AI. For example, the digitization unit can input the user's social media activity data into a generative AI and have the generative AI digitize data reflecting trends.

The digitization unit can prioritize digitization of optimal data by taking into account the user's health condition. For example, if the user is tired, the digitization unit prioritizes important data. If the user is healthy, the digitization unit can also prioritize detailed data. If the user is in poor physical condition, the digitization unit can also prioritize essential data. By prioritizing digitization of data according to the user's health condition, appropriate data can be provided. Some or all of the above processing in the digitization unit may be performed using AI or without using AI. For example, the digitization unit can input the user's health condition data into a generative AI and have the generative AI prioritize digitization of data based on health condition.

The system according to the embodiment is not limited to the above examples and, for example, various modifications are possible as described below.

The proposal unit can estimate the user's emotions and adjust the type of proposed deck based on the estimated emotions of the user. For example, if the user is feeling stressed, the proposal unit proposes a defense-oriented deck that allows the user to relax. If the user is excited, the proposal unit can also propose a deck containing many aggressive cards. If the user is calm, the proposal unit can also propose a balanced deck. By proposing a deck according to the user's emotions, a more appropriate deck can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the proposal unit may be performed using AI or without using AI. For example, the proposal unit can input the user's emotion data into a generative AI and have the generative AI generate proposals for decks based on emotions.

The proposal unit can analyze data of the user's past opponents and propose a deck effective against a specific opponent. For example, the proposal unit analyzes the deck composition of opponents the user has played against in the past and proposes a deck containing cards effective against those opponents. If the user has struggled against a specific opponent, the proposal unit can also propose a deck to break that opponent's strategy. The proposal unit can also propose a deck that adopts a similar strategy to the decks of opponents the user has defeated in the past. By proposing a deck effective against a specific opponent, the win rate of matches can be improved. Some or all of the above processing in the proposal unit may be performed using AI or without using AI. For example, the proposal unit can input the user's past opponent data into a generative AI and have the generative AI generate proposals for decks effective against specific opponents.

The proposal unit can adjust the difficulty of the deck based on the user's current in-game rank or score. For example, if the user is a beginner, the proposal unit proposes a deck containing many basic cards. If the user is an intermediate player, the proposal unit can also propose a deck containing many strategic cards. If the user is an advanced player, the proposal unit can also propose a deck containing complex combos. By proposing a deck according to the user's rank or score, a deck of appropriate difficulty can be provided. Some or all of the above processing in the proposal unit may be performed using AI or without using AI. For example, the proposal unit can input the user's in-game rank or score into a generative AI and have the generative AI adjust the difficulty of the deck.

The proposal unit can estimate the user's emotions and adjust the order of cards in the proposed deck based on the estimated emotions of the user. For example, if the user is nervous, the proposal unit proposes a deck with many defense cards placed at the beginning. If the user is relaxed, the proposal unit can also propose a deck with many attack cards placed at the beginning. If the user is excited, the proposal unit can also propose a deck with powerful cards placed at the beginning. By proposing the order of cards according to the user's emotions, a more effective deck can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the proposal unit may be performed using AI or without using AI. For example, the proposal unit can input the user's emotion data into a generative AI and have the generative AI adjust the order of cards based on emotions.

The proposal unit can propose a deck reflecting region-specific strategies by taking into account the user's geographic location information. For example, if the user lives in a cold region, the proposal unit proposes a deck containing many ice-attribute cards. If the user lives in a tropical region, the proposal unit can also propose a deck containing many fire-attribute cards. If the user lives in an urban area, the proposal unit can also propose a deck containing many machine-attribute cards. By proposing a deck reflecting region-specific strategies, a deck suitable for the user can be provided. Some or all of the above processing in the proposal unit may be performed using AI or without using AI. For example, the proposal unit can input the user's geographic location information into a generative AI and have the generative AI generate proposals for decks reflecting region-specific strategies.

The proposal unit can analyze the user's social media activity and propose a deck reflecting relevant trends. For example, the proposal unit proposes a deck containing many cards that are trending on the user's social media. The proposal unit can also propose a deck based on the decks used by influencers followed by the user. The proposal unit can also propose a deck containing many cards popular in communities the user participates in. By proposing a deck reflecting social media trends, the user can be provided with the latest decks. Some or all of the above processing in the proposal unit may be performed using AI or without using AI. For example, the proposal unit can input the user's social media activity data into a generative AI and have the generative AI generate proposals for decks reflecting trends.

The battle unit can estimate the user's emotions and adjust the difficulty of the match based on the estimated emotions of the user. For example, if the user is nervous, the battle unit sets the strength of the opponent low. If the user is relaxed, the battle unit can also set the strength of the opponent to a medium level. If the user is excited, the battle unit can also set the strength of the opponent high. By providing matches of difficulty according to the user's emotions, an appropriate match environment can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the battle unit may be performed using AI or without using AI. For example, the battle unit can input the user's emotion data into a generative AI and have the generative AI adjust the difficulty of the match based on emotions.

The battle unit can refer to the user's past match history and strengthen countermeasures against specific strategies. For example, the battle unit sets up AI with enhanced countermeasures against strategies the user has struggled with in the past. The battle unit can also set up AI that adopts similar strategies to those the user has defeated in the past. The battle unit can also analyze strategies the user has used in the past and set up AI with enhanced countermeasures against those strategies. By referring to past match history, countermeasures against specific strategies can be strengthened. Some or all of the above processing in the battle unit may be performed using AI or without using AI. For example, the battle unit can input the user's past match history data into a generative AI and have the generative AI strengthen countermeasures against specific strategies.

The battle unit can dynamically change the AI's strategy according to the user's play style. For example, if the user adopts an aggressive play style, the AI adopts a defense-oriented strategy. If the user adopts a defensive play style, the AI can also adopt an attack-oriented strategy. If the user adopts a balanced play style, the AI can also flexibly change its strategy. By providing strategies according to the user's play style, more effective matches can be realized. Some or all of the above processing in the battle unit may be performed using AI or without using AI. For example, the battle unit can input the user's play style data into a generative AI and have the generative AI dynamically change the AI's strategy.

The battle unit can estimate the user's emotions and adjust the tempo of the match based on the estimated emotions of the user. For example, if the user is nervous, the battle unit slows down the tempo of the match. If the user is relaxed, the battle unit can also set the tempo to normal. If the user is excited, the battle unit can also speed up the tempo of the match. By providing matches with a tempo according to the user's emotions, an appropriate match environment can be provided. Emotion estimation is realized, for example, by using an emotion estimation function such as an emotion engine or generative AI. The generative AI may be a text generation AI (e.g., LLM) or a multimodal generative AI, but is not limited to such examples. Some or all of the above processing in the battle unit may be performed using AI or without using AI. For example, the battle unit can input the user's emotion data into a generative AI and have the generative AI adjust the tempo of the match based on emotions.

The following is a brief description of the processing flow of Example 2 of the Embodiment.

Step 1: The proposal unit proposes an optimal card deck based on the user's personality, preferred style, past deck information, and battle history. For example, the proposal unit analyzes decks and match results previously used by the user with AI and proposes a deck that matches the user's play style. For users who prefer an aggressive play style, a deck containing many high-attack cards is proposed; for users who prefer a defensive play style, a deck containing many high-defense cards is proposed; and for users who prefer a balanced play style, a deck with a balance of attack and defense is proposed.

Step 2: The battle unit conducts a virtual match against AI using the deck proposed by the proposal unit. For example, by playing against AI, the user can practice in an environment close to an actual match. The battle unit allows the user to learn how to respond to various strategies by having the AI operate the opponent using different strategies. When the AI takes an aggressive strategy, the user can try a defensive strategy, and when the AI takes a defensive strategy, the user can try an aggressive strategy. Furthermore, when the AI takes a balanced strategy, the user can try various strategies.

Step 3: The analysis unit visually analyzes the results of the match conducted by the battle unit. For example, the system is equipped with a function in which AI operates the opponent on a virtual battlefield and visually analyzes the strategy. The user can visually check the movements of the opponent operated by AI and understand the strategy. By visually showing the timing and order in which the AI uses specific cards, the user can learn the strategy. The system can also visually show the effects of strategies used by the AI during the match. For example, the effects of cards used by the AI can be displayed in graphs or heat maps.

Step 4: The improvement unit proposes improvements to the play style based on the results obtained by the analysis unit. For example, the AI analyzes mistakes and points for improvement made by the user during the match and provides specific advice. By proposing improvements to the timing of using specific cards or changes in strategy, the user's play style can be improved. The system can propose improvements to the timing of using specific cards, changes to specific strategies, and trying new strategies.

Step 5: The digitization unit digitizes usage information of physical decks. For example, the system collects information on physical decks actually used by the user with sensors and AI analyzes the data. The user can check the performance of the deck in real time and adjust the deck as necessary. The system digitizes the types and usage frequency of cards used by the user, and AI evaluates the performance of the deck based on the data.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned proposal unit, battle unit, analysis unit, improvement unit, and digitization unit is realized by at least one of, for example, the smart device 14 and the data processing apparatus 12. For example, the proposal unit is realized by the control unit 46A of the smart device 14 and proposes an optimal deck based on the user's personality and play style. The battle unit is realized, for example, by the specific processing unit 290 of the data processing apparatus 12 and conducts virtual matches against AI. The analysis unit is realized, for example, by the control unit 46A of the smart device 14 and visually analyzes match results. The improvement unit is realized, for example, by the specific processing unit 290 of the data processing apparatus 12 and proposes improvements to the play style. The digitization unit is realized, for example, by the control unit 46A of the smart device 14 and digitizes usage information of physical decks. The correspondence between each unit and the device or control unit is not limited to the above examples and various modifications are possible.

### Second Embodiment

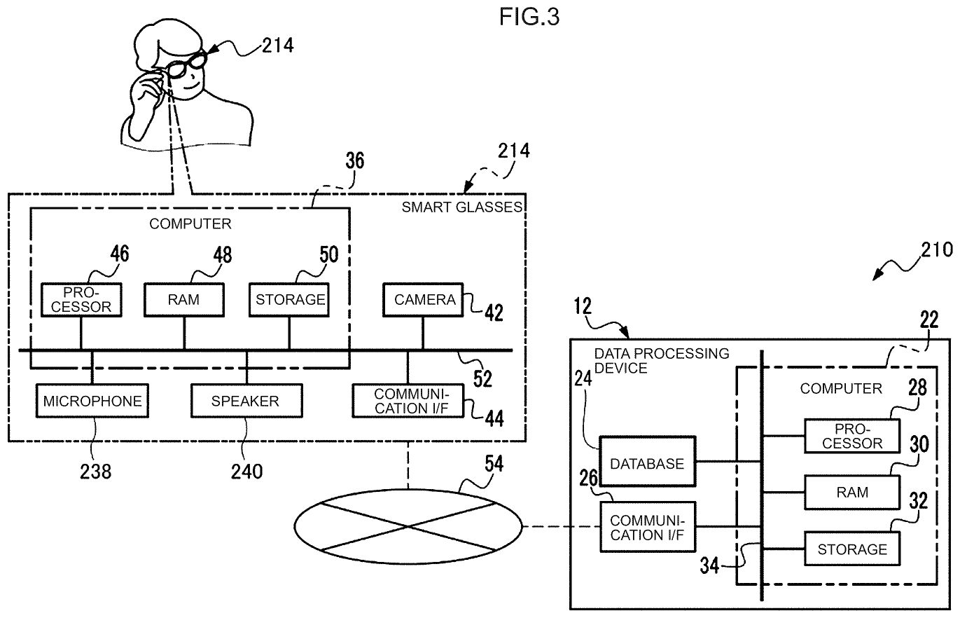

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

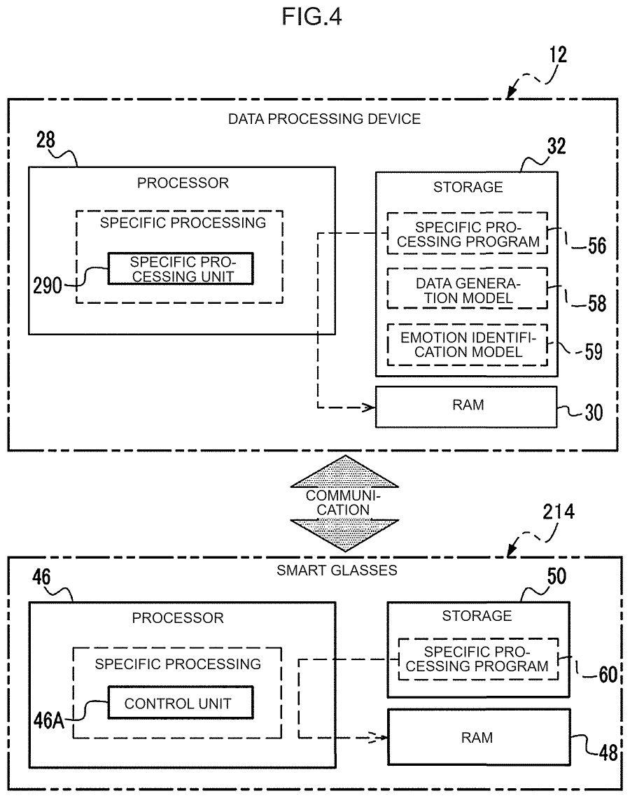

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned proposal unit, battle unit, analysis unit, improvement unit, and digitization unit is realized by at least one of, for example, the smart glasses 214 and the data processing apparatus 12. For example, the proposal unit is realized by the control unit 46A of the smart glasses 214 and proposes an optimal deck based on the user's personality and play style. The battle unit is realized, for example, by the specific processing unit 290 of the data processing apparatus 12 and conducts virtual matches against AI. The analysis unit is realized, for example, by the control unit 46A of the smart glasses 214 and visually analyzes match results. The improvement unit is realized, for example, by the specific processing unit 290 of the data processing apparatus 12 and proposes improvements to the play style. The digitization unit is realized, for example, by the control unit 46A of the smart glasses 214 and digitizes usage information of physical decks. The correspondence between each unit and the device or control unit is not limited to the above examples and various modifications are possible.

### Third Embodiment

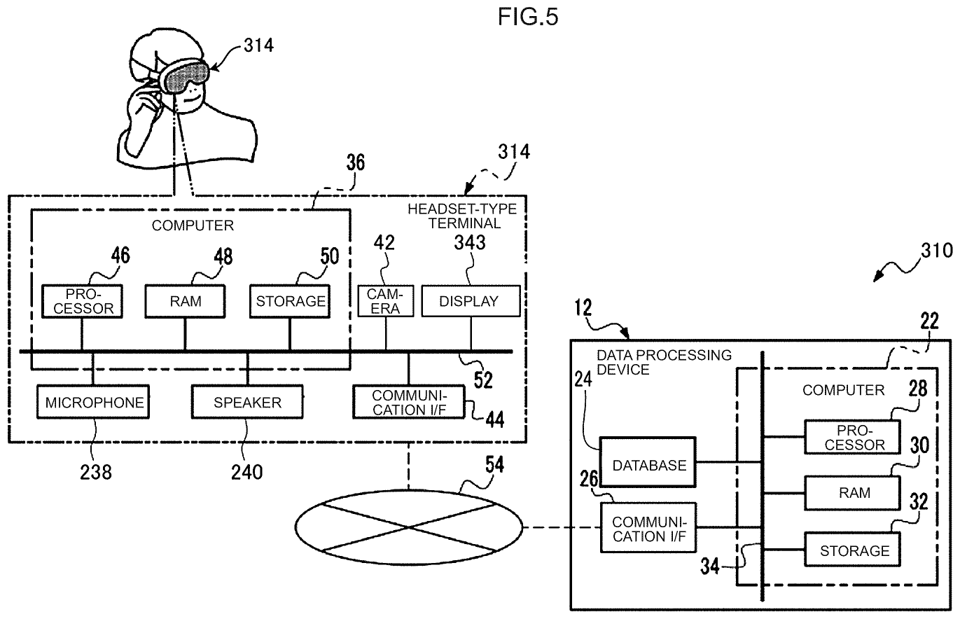

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

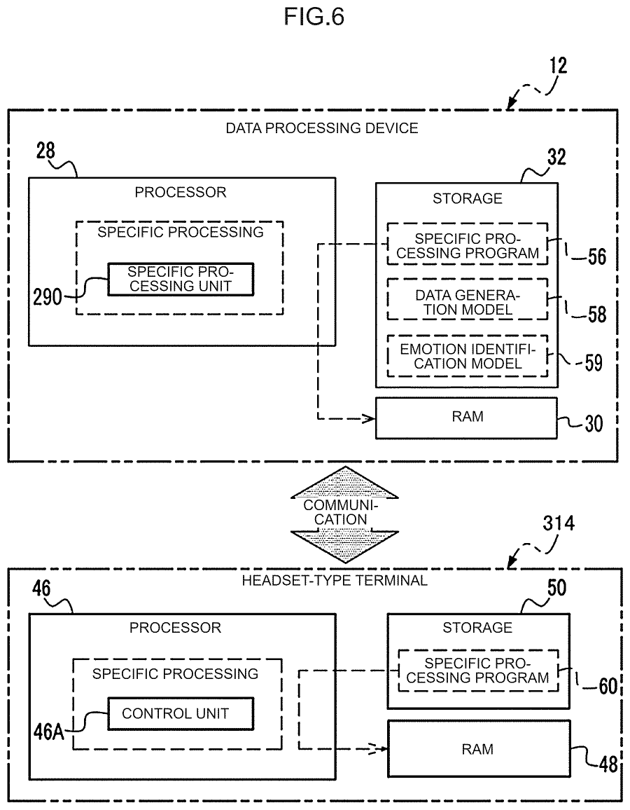

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned proposal unit, battle unit, analysis unit, improvement unit, and digitization unit is realized by at least one of, for example, the headset-type terminal 314 and the data processing apparatus 12. For example, the proposal unit is realized by the control unit 46A of the headset-type terminal 314 and proposes an optimal deck based on the user's personality and play style. The battle unit is realized, for example, by the specific processing unit 290 of the data processing apparatus 12 and conducts virtual matches against AI. The analysis unit is realized, for example, by the control unit 46A of the headset-type terminal 314 and visually analyzes match results. The improvement unit is realized, for example, by the specific processing unit 290 of the data processing apparatus 12 and proposes improvements to the play style. The digitization unit is realized, for example, by the control unit 46A of the headset-type terminal 314 and digitizes usage information of physical decks. The correspondence between each unit and the device or control unit is not limited to the above examples and various modifications are possible.

### Fourth Embodiment

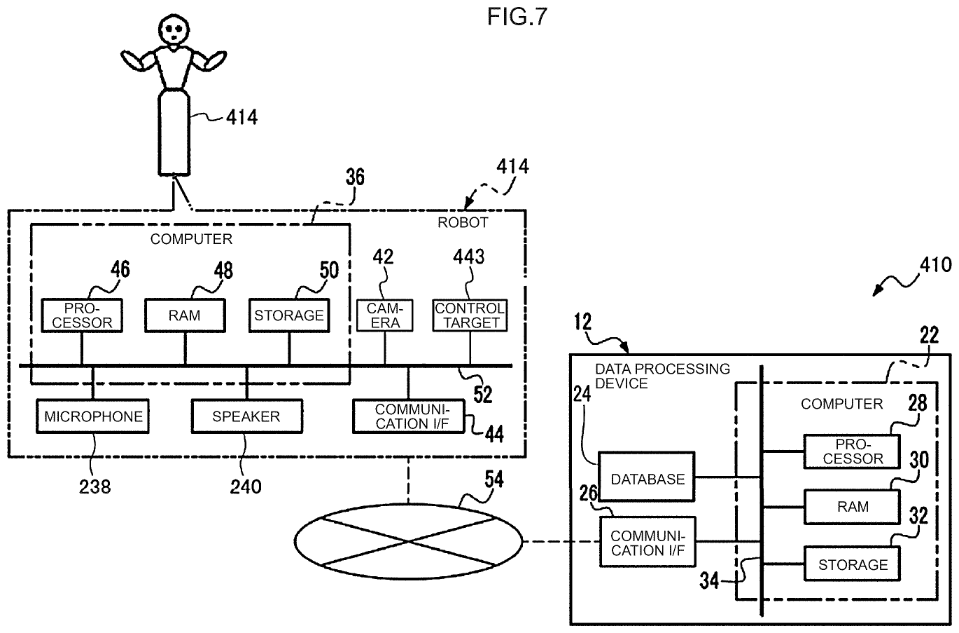

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

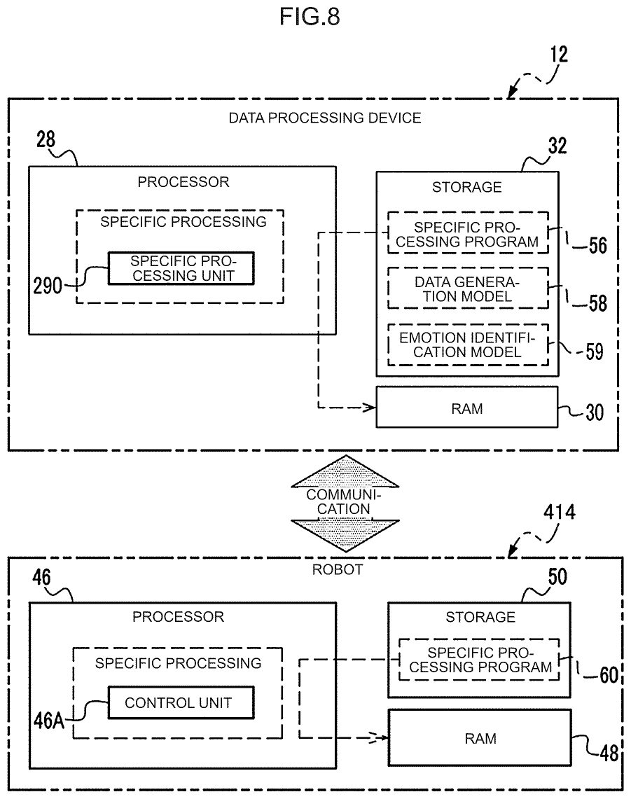

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned proposal unit, battle unit, analysis unit, improvement unit, and digitization unit is realized by at least one of, for example, the robot 414 and the data processing apparatus 12. For example, the proposal unit is realized by the control unit 46A of the robot 414 and proposes an optimal deck based on the user's personality and play style. The battle unit is realized, for example, by the specific processing unit 290 of the data processing apparatus 12 and conducts virtual matches against AI. The analysis unit is realized, for example, by the control unit 46A of the robot 414 and visually analyzes match results. The improvement unit is realized, for example, by the specific processing unit 290 of the data processing apparatus 12 and proposes improvements to the play style. The digitization unit is realized, for example, by the control unit 46A of the robot 414 and digitizes usage information of physical decks. The correspondence between each unit and the device or control unit is not limited to the above examples and various modifications are possible.

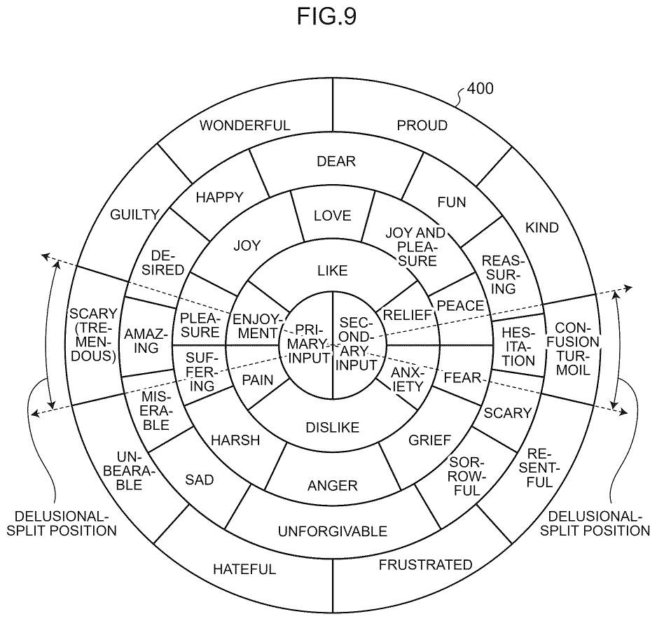

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

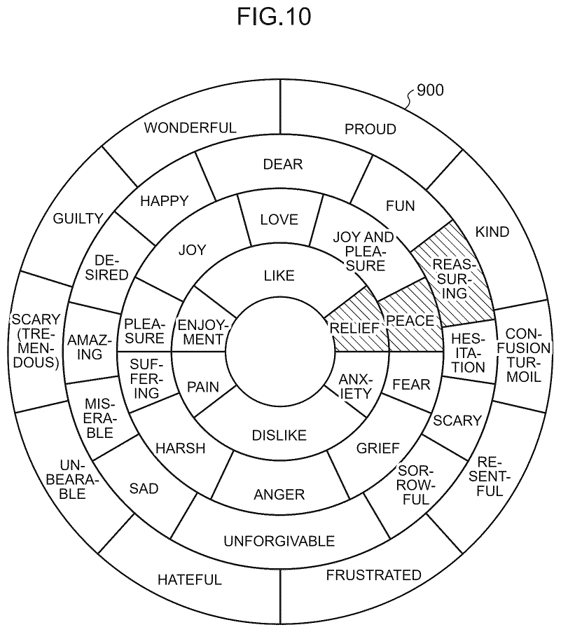

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
[Additional Note 1] A system including: a proposal unit configured to propose an optimal card deck based on the user's personality, preferred style, past deck information, and battle history; a battle unit configured to conduct a virtual match against AI using the deck proposed by the proposal unit; an analysis unit configured to visually analyze the results of the match conducted by the battle unit; an improvement unit configured to propose improvements to the play style based on the results obtained by the analysis unit; and a digitization unit configured to digitize usage information of physical decks.
[Additional Note 2] The system according to Additional Note 1, wherein the proposal unit is configured to estimate the user's emotions and adjust the type of proposed deck based on the estimated emotions of the user.
[Additional Note 3] The system according to Additional Note 1, wherein the proposal unit is configured to analyze data of the user's past opponents and propose a deck effective against a specific opponent.
[Additional Note 4] The system according to Additional Note 1, wherein the proposal unit is configured to adjust the difficulty of the deck based on the user's current in-game rank or score.
[Additional Note 5] The system according to Additional Note 1, wherein the proposal unit is configured to estimate the user's emotions and adjust the order of cards in the proposed deck based on the estimated emotions of the user.
[Additional Note 6] The system according to Additional Note 1, wherein the proposal unit is configured to propose a deck reflecting region-specific strategies by taking into account the user's geographic location information.
[Additional Note 7] The system according to Additional Note 1, wherein the proposal unit is configured to analyze the user's social media activity and propose a deck reflecting relevant trends.
[Additional Note 8] The system according to Additional Note 1, wherein the battle unit is configured to estimate the user's emotions and adjust the difficulty of the match based on the estimated emotions of the user.
[Additional Note 9] The system according to Additional Note 1, wherein the battle unit is configured to refer to the user's past match history and strengthen countermeasures against specific strategies.
[Additional Note 10] The system according to Additional Note 1, wherein the battle unit is configured to dynamically change the AI's strategy according to the user's play style.
[Additional Note 11] The system according to Additional Note 1, wherein the battle unit is configured to estimate the user's emotions and adjust the tempo of the match based on the estimated emotions of the user.
[Additional Note 12] The system according to Additional Note 1, wherein the battle unit is configured to conduct matches reflecting region-specific strategies by taking into account the user's geographic location information.
[Additional Note 13] The system according to Additional Note 1, wherein the battle unit is configured to analyze the user's social media activity and conduct matches reflecting relevant trends.
[Additional Note 14] The system according to Additional Note 1, wherein the analysis unit is configured to estimate the user's emotions and adjust the display method of analysis results based on the estimated emotions of the user.
[Additional Note 15] The system according to Additional Note 1, wherein the analysis unit is configured to refer to the user's past match data and analyze the effectiveness of specific strategies in detail.
[Additional Note 16] The system according to Additional Note 1, wherein the analysis unit is configured to apply different analysis algorithms according to the user's play style.
[Additional Note 17] The system according to Additional Note 1, wherein the analysis unit is configured to estimate the user's emotions and determine the priority of analysis results based on the estimated emotions of the user.
[Additional Note 18] The system according to Additional Note 1, wherein the analysis unit is configured to conduct analysis reflecting region-specific strategies by taking into account the user's geographic location information.
[Additional Note 19] The system according to Additional Note 1, wherein the analysis unit is configured to analyze the user's social media activity and conduct analysis reflecting relevant trends.
[Additional Note 20] The system according to Additional Note 1, wherein the improvement unit is configured to estimate the user's emotions and adjust the content of improvement proposals based on the estimated emotions of the user.
[Additional Note 21] The system according to Additional Note 1, wherein the improvement unit is configured to refer to the user's past match data and propose specific improvement measures for particular weaknesses.
[Additional Note 22] The system according to Additional Note 1, wherein the improvement unit is configured to apply different improvement algorithms according to the user's play style.
[Additional Note 23] The system according to Additional Note 1, wherein the improvement unit is configured to estimate the user's emotions and determine the priority of improvement proposals based on the estimated emotions of the user.
[Additional Note 24] The system according to Additional Note 1, wherein the improvement unit is configured to propose improvement measures reflecting region-specific strategies by taking into account the user's geographic location information.
[Additional Note 25] The system according to Additional Note 1, wherein the improvement unit is configured to analyze the user's social media activity and propose improvement measures reflecting relevant trends.
[Additional Note 26] The system according to Additional Note 1, wherein the digitization unit is configured to estimate the user's emotions and adjust the type of data to be digitized based on the estimated emotions of the user.
[Additional Note 27] The system according to Additional Note 1, wherein the digitization unit is configured to refer to the user's past deck usage data and record the usage frequency of specific cards in detail.
[Additional Note 28] The system according to Additional Note 1, wherein the digitization unit is configured to apply different digitization algorithms according to the user's play style.
[Additional Note 29] The system according to Additional Note 1, wherein the digitization unit is configured to estimate the user's emotions and determine the priority of data to be digitized based on the estimated emotions of the user.
[Additional Note 30] The system according to Additional Note 1, wherein the digitization unit is configured to prioritize digitization of region-specific data by taking into account the user's geographic location information.
[Additional Note 31] The system according to Additional Note 1, wherein the digitization unit is configured to analyze the user's social media activity and digitize data reflecting relevant trends.
[Additional Note 32] The system according to Additional Note 1, wherein the digitization unit is configured to prioritize digitization of optimal data by taking into account the user's health condition.

What is claimed is:

1. A system comprising: a proposal unit configured to propose an optimal card deck based on the user's personality, preferred style, past deck information, and battle history; a battle unit configured to conduct a virtual match against AI using the deck proposed by the proposal unit; an analysis unit configured to visually analyze the results of the match conducted by the battle unit; an improvement unit configured to propose improvements to the play style based on the results obtained by the analysis unit; and a digitization unit configured to digitize usage information of physical decks.

2. The system according to claim 1, wherein the proposal unit is configured to estimate the user's emotions and adjust the type of proposed deck based on the estimated emotions of the user.

3. The system according to claim 1, wherein the proposal unit is configured to analyze data of the user's past opponents and propose a deck effective against a specific opponent.

4. The system according to claim 1, wherein the proposal unit is configured to adjust the difficulty of the deck based on the user's current in-game rank or score.

5. The system according to claim 1, wherein the proposal unit is configured to estimate the user's emotions and adjust the order of cards in the proposed deck based on the estimated emotions of the user.

6. The system according to claim 1, wherein the proposal unit is configured to propose a deck reflecting region-specific strategies by taking into account the user's geographic location information.

7. The system according to claim 1, wherein the proposal unit is configured to analyze the user's social media activity and propose a deck reflecting relevant trends.

8. The system according to claim 1, wherein the battle unit is configured to estimate the user's emotions and adjust the difficulty of the match based on the estimated emotions of the user.
